(19) United States
(12) Patent Application Publication
(10) Pub. No.: US 2025/0332961 A1
(43) Pub. Date: Oct. 30, 2025

(54) Vehicle

(71) Applicant: TOYOTA JIDOSHA KABUSHIKI KAISHA, Toyota-shi Aichi-ken (JP)

(72) Inventor: Daisuke KAMESAKI, Okazaki-shi Aichi-ken (JP)

(73) Assignee: TOYOTA JIDOSHA KABUSHIKI KAISHA, Toyota-shi Aichi-ken (JP)

(21) Appl. No.: 19/184,551

(22) Filed: Apr. 21, 2025

(30) Foreign Application Priority Data
Apr. 24, 2024 (JP) 2024-070701

(51) Int. Cl. B60L 58/26; A62C 3/06; A62C 3/07; B60L 50/64

(52) U.S. Cl. CPC B60L 58/26; B60L 50/64; A62C 3/06; A62C 3/07

(57) ABSTRACT

A vehicle includes: one or more power storage stacks; a housing case; a cooler placed adjacent to the housing case, refrigerant being allowed to flow through the cooler; and a refrigerant circulation path that is placed outside the housing case and allows the refrigerant discharged from the cooler to be circulated through the refrigerant circulation path and introduced again into the cooler, the refrigerant circulation path is equipped with an extinguishant inlet that allows an extinguishant to be introduced into the refrigerant circulation path, the cooler is equipped with a fragile portion to be broken by pressure of the extinguishant introduced from the extinguishant inlet into the refrigerant circulation path, to cause an inside of the housing case to communicate with the refrigerant circulation path, and the housing case is equipped with a pressure release valve located higher than the one or more power storage stacks.

### CROSS REFERENCE TO RELATED APPLICATIONS

This nonprovisional application is based on Japanese Patent Application No. 2024-070701 filed on Apr. 24, 2024 with the Japan Patent Office, the entire contents of which are hereby incorporated by reference.

### BACKGROUND

### Field

The present disclosure relates to a vehicle.

### Description of the Background Art

As a conventional vehicle, Japanese Patent Laying-Open No. 2013-136266 discloses a structure in which a battery pack (power storage device) in which a battery (power storage stack) is housed in a pack case (housing case) is provided, a heat absorbing portion disposed in the pack case and a heat dissipation portion disposed outside the pack case are connected by a coolant circulation path, and the battery is cooled by circulation of the coolant.

An extinguishant inlet into which an extinguishant can be injected is provided in a portion of the coolant circulation path located outside the pack case. A portion of the coolant circulation path located in the pack case is provided with a fragile portion that is broken by the pressure of the extinguishant when the extinguishant is injected. By providing the extinguishant inlet and the fragile portion in the coolant circulation path as described above, the coolant circulation path can be used as a path for supplying the extinguishant into the pack case.

### SUMMARY

However, in the vehicle disclosed in Japanese Patent Laying-Open No. 2013-136266, after the extinguishant is introduced into the pack case, the introduced extinguishant is kept in the pack case and is not replaced with a new extinguishant. Further, as the extinguishant is introduced, the pressure in the pack case increases, and the entire battery may not be immersed in the extinguishant. Therefore, there is a concern that the temperature of the battery disposed in the pack case cannot be lowered sufficiently.

The present disclosure is given in view of the problems as described above, and an object of the present disclosure is to provide a vehicle capable of effectively supplying an extinguishant to a power storage stack when the power storage stack generates heat.

A vehicle according to the present disclosure includes: one or more power storage stacks; a housing case that houses the one or more power storage stacks; a cooler that is placed adjacent to the housing case, refrigerant for cooling the one or more power storage stacks being allowed to flow through the cooler; and a refrigerant circulation path that is placed outside the housing case and allows the refrigerant discharged from the cooler to be circulated through the refrigerant circulation path and introduced again into the cooler. The refrigerant circulation path is equipped with an extinguishant inlet that allows an extinguishant to be introduced into the refrigerant circulation path. The cooler is equipped with a fragile portion to be broken by pressure of the extinguishant introduced from the extinguishant inlet into the refrigerant circulation path, to cause an inside of the housing case to communicate with the refrigerant circulation path. The housing case is equipped with a pressure release valve located higher than the one or more power storage stacks.

The above-described configuration enables the fragile portion provided in the cooler to be broken by the extinguishant introduced from the extinguishant inlet, when one or more power storage stacks generate heat so that the extinguishant is required to be supplied to the one or more power storage stacks. Accordingly, the inside of the cooler and therefore the refrigerant circulation path communicate with the inside of the housing case, so that the refrigerant and the extinguishant flowing in the cooler can be introduced into the housing case. At this time, since the pressure release valve is located higher than the one or more power storage stacks, the pressure release valve is opened when the pressure inside the housing case becomes equal to or more than a predetermined pressure due to the supplied extinguishant. Accordingly, the extinguishant can be supplied into the housing case to reach the position of the pressure release valve, which enables one or more power storage stacks to be immersed reliably in the extinguishant. In addition, since the extinguishant is discharged from the opened pressure release valve, a new extinguishant at a lower temperature can effectively be supplied into the housing case. In this way, the temperature of the power storage stack(s) can be lowered effectively.

In the vehicle based on the present disclosure, the housing case includes a facing wall portion facing the cooler. In this case, the facing wall portion may include a part that faces the fragile portion, and the part may be equipped with a case-side fragile portion to be broken by pressure of the extinguishant introduced into the refrigerant circulation path.

The above-described configuration enables the inside of the cooler to communicate with the inside of the housing case, by breakage of the fragile portion and the case-side fragile portion due to the extinguishant introduced into the refrigerant circulation path.

In the vehicle based on the present disclosure, the fragile portion may be located lower than the one or more power storage stacks.

The above-described configuration enables the extinguishant to be introduced into the housing case from a position lower than the one or more power storage stacks, and enables the extinguishant introduced into the housing case to be discharged to the outside from the pressure release valve located higher than the one or more power storage stacks.

In the vehicle based on the present disclosure, the one or more power storage stacks may include a plurality of power storage stacks arranged in a first direction orthogonal to a top-bottom direction. As seen in the top-bottom direction, the fragile portion may be located between the power storage stacks adjacent to each other in the first direction.

The above-described configuration enables the extinguishant to be introduced into the housing case, through the gap located between the power storage stacks adjacent to each other.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic diagram of a vehicle according to an embodiment.

FIG. 2 is a schematic diagram showing a fire extinguishing structure of the vehicle according to the embodiment.

FIG. 3 is a diagram illustrating a state in which the fire extinguishing structure of the vehicle according to the embodiment is operated.

### DESCRIPTION OF THE EMBODIMENTS

Hereinafter, embodiments of the present disclosure will be described in detail with reference to the drawings. In the following embodiments, the same or common parts are denoted by the same reference numerals in the drawings, and the description thereof will not be repeated.

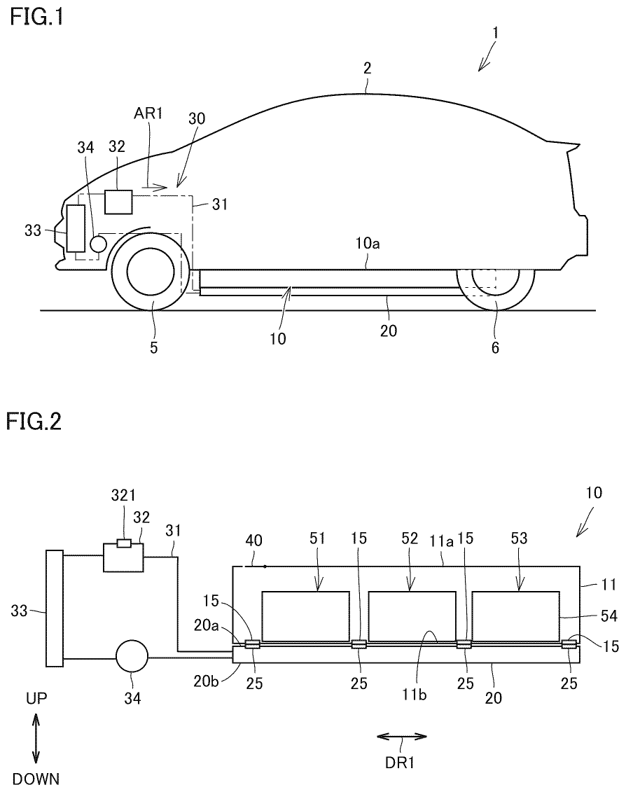

FIG. 1 is a schematic diagram of a vehicle according to an embodiment. A vehicle 1 according to an embodiment will be described with reference to FIG. 1.

The vehicle 1 is a hybrid electric vehicle that can travel using power of at least one of a motor and an engine, or an electrically powered vehicle that travels using a driving force obtained by electric energy.

The vehicle 1 includes a vehicle main body 2, a front wheel 5, a rear wheel 6, a power storage device 10, a cooler 20, and a refrigerant circulation path 30. The power storage device 10 is fixed to a lower portion of the vehicle main body 2. An upper surface 10a of the power storage device 10 may function as a floor panel. The upper surface 10a may not function as a floor panel and, in this case, the power storage device 10 is disposed below the floor panel.

The cooler 20 is disposed adjacent to the power storage device 10. The cooler 20 is located, for example, below the power storage device 10. A refrigerant for cooling a plurality of power storage stacks 51, 52, and 53 (see FIG. 2) described later flows through the cooler 20.

The refrigerant circulation path 30 is a path for circulating the refrigerant such that the refrigerant discharged from the cooler 20 is introduced into the cooler 20 again. Similarly to the cooler 20, the refrigerant circulation path 30 is provided outside a housing case 11 (see FIG. 2) described later. Accordingly, when the plurality of power storage stacks 51, 52, and 53 are cooled in a normal state, it is possible to prevent the refrigerant flowing through the refrigerant circulation path 30 and the cooler 20 from entering the housing case 11. As a result, it is possible to prevent the plurality of power storage stacks 51, 52, and 53 from being short-circuited by the refrigerant during normal operation.

The refrigerant circulation path 30 includes a pipe 31, a tank 32, a heat dissipation portion 33, and a pump 34. The pipe 31 connects the tank 32, the heat dissipation portion 33, the pump 34, and the cooler 20 in series.

The tank 32 stores a refrigerant. The heat dissipation portion 33 is, for example, a heat exchanger. For example, the heat dissipation portion 33 dissipates the heat of the refrigerant discharged from the cooler 20 to the outside air. The pump 34 circulates the refrigerant in a direction AR1 in FIG. 1. The pump 34 is driven by a conduction motor.

Note that, in FIG. 1, a case where the tank 32, the heat dissipation portion 33, and the pump 34 are arranged on the front side of the vehicle 1 is illustrated by way of example, however, the tank 32, the heat dissipation portion 33, and the pump 34 may be arranged at an appropriate position and connected by the pipe 31.

FIG. 2 is a schematic diagram showing a fire extinguishing structure of the vehicle according to the embodiment. As illustrated in FIG. 2, the fire extinguishing structure of the vehicle 1 includes the power storage device 10, the cooler 20, and the refrigerant circulation path 30.

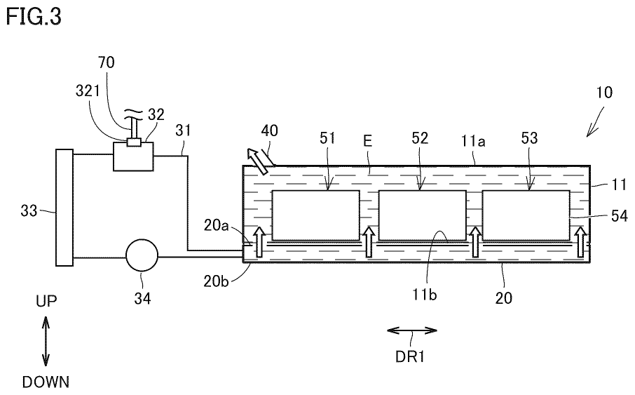

The refrigerant circulation path 30 is provided with an extinguishant inlet 321 for introducing the extinguishant E (see FIG. 3). Specifically, the extinguishant inlet 321 is provided in the tank 32. More specifically, the extinguishant inlet 321 is provided in the upper wall of the tank 32. The extinguishant inlet 321 is provided so that a tip portion (extinguishant outlet) of a water discharge hose 70 (see FIG. 3) or the like extending from a fire extinguishing vehicle or fire extinguishing equipment can be inserted. The extinguishant inlet 321 is provided to be openable and closable by using a lid member or the like.

The power storage device 10 includes a plurality of power storage stacks 51, 52, and 53, and the housing case 11. The housing case 11 houses a plurality of power storage stacks 51, 52, and 53.

The plurality of power storage stacks 51, 52, and 53 are arranged at intervals in a first direction (DR1 direction) orthogonal to the top-bottom direction. The first direction is, for example, parallel to the front-rear direction of the vehicle 1. Each of the plurality of power storage stacks 51, 52, and 53 includes a plurality of power storage cells 54 arranged in a second direction orthogonal to the top-bottom direction and the first direction. The second direction is, for example, parallel to the width direction of the vehicle 1.

In the present embodiment, the case where the number of power storage stacks is three is exemplified, but the number of power storage stacks is not limited to three and may be one or more.

The power storage cell 54 is a secondary battery such as a nickel-metal hydride battery or a lithium ion battery. The power storage cell 54 may use a liquid electrolyte or a solid electrolyte. The power storage cell 54 may be a chargeable/dischargeable capacitor.

The housing case 11 has a top wall portion 11a and a bottom wall portion 11b arranged in the top-bottom direction. The top wall portion 11a constitutes the upper surface 10a of the power storage device 10 described above. The bottom wall portion 11b corresponds to a facing wall portion facing the cooler 20.

The housing case 11 is provided with a pressure release valve 40 at a position higher than the plurality of power storage stacks 51, 52, and 53. Specifically, the pressure release valve 40 is provided in the top wall portion 11a. The pressure release valve 40 is opened when the internal pressure in the housing case 11 becomes equal to or higher than a predetermined pressure. The pressure release valve 40 may have a function of exhausting the gas to the outside of the housing case 11 when the gas is exhausted from the plurality of power storage stacks 51, 52, and 53.

A case-side fragile portion 15 is provided in a portion of the bottom wall portion 11b facing a fragile portion 25 of the cooler 20 described later. The case-side fragile portion 15 is provided so as to be broken by the pressure of the extinguishant E introduced into the refrigerant circulation path 30 as described later. The case-side fragile portion 15 is provided to be thinner than other portions of the bottom wall portion 11b, for example.

The case-side fragile portion 15 is disposed between the power storage stacks adjacent to each other in the first direction when viewed in a plan view (when viewed from above). More specifically, the case-side fragile portion 15 is disposed between the side wall portion of the housing case 11 located on one side in the first direction and the power storage stack 51 (power storage stack located closest to one side in the first direction among a plurality of power storage stacks), between the power storage stack 51 and the power storage stack 52, between the power storage stack 52 and the power storage stack 53, and between the side wall portion of the housing case 11 located on the other side in the first direction and the power storage stack 53 (power storage stack located closest to the other side in the first direction among a plurality of power storage stacks), when viewed in a plan view.

The cooler 20 includes an upper wall portion 20a and a lower wall portion 20b. A flow path through which the refrigerant flows is provided between the upper wall portion 20a and the lower wall portion 20b.

The cooler 20 is provided with a fragile portion 25 that is broken by the pressure of the extinguishant E introduced into the refrigerant circulation path 30 from the extinguishant inlet 321 and allows the inside of the housing case 11 and the refrigerant circulation path 30 to communicate with each other. Specifically, the fragile portion 25 is provided in a wall portion of the cooler 20 adjacent to the housing case 11. More specifically, the fragile portion 25 is provided in the upper wall portion 20a. The fragile portion 25 is provided at a position lower than the plurality of power storage stacks 51, 52, and 53. For example, the fragile portion 25 is provided to be thinner than other portions of the housing case 11.

The fragile portion 25 is disposed between the power storage stacks adjacent to each other in the first direction when viewed in a plan view (when viewed from above). More specifically, the fragile portion 25 is disposed between the side wall portion of the housing case 11 located on one side in the first direction and the power storage stack 51 (power storage stack located closest to one side in the first direction among a plurality of power storage stacks), between the power storage stack 51 and the power storage stack 52, between the power storage stack 52 and the power storage stack 53, and between the side wall portion of the housing case 11 located on the other side in the first direction and the power storage stack 53 (power storage stack located closest to the other side in the first direction among a plurality of power storage stacks), when viewed in a plan view.

FIG. 3 is a diagram illustrating a state in which the fire extinguishing structure of the vehicle according to the embodiment is operated. As shown in FIG. 3, when at least one of the plurality of power storage stacks 51, 52, and 53 generates heat and it becomes necessary to supply the extinguishant to the heat-generating power storage stack, the extinguishant inlet 321 is opened and the extinguishant E is introduced into the refrigerant circulation path 30. Specifically, for example, the tip portion of the water discharge hose 70 or the like is inserted into the extinguishant inlet 321 to discharge water.

When the extinguishant E is introduced into the refrigerant circulation path 30 in this manner, the fragile portion 25 of the cooler 20 and the case-side fragile portion 15 of the housing case 11 are broken by the pressure of the extinguishant E. Thus, the interior of the cooler 20 communicates with the interior of the housing case 11, and the refrigerant and the extinguishant E flowing through the cooler 20 can be introduced into the housing case 11.

At this time, since the pressure release valve 40 is provided at a position higher than the power storage stacks 51, 52, and 53, the pressure release valve 40 is opened when the inside of the housing case 11 becomes equal to or higher than a predetermined pressure at the time of supplying the extinguishant E.

Accordingly, the extinguishant E can be supplied into the housing case 11 to the position of the pressure release valve 40, and the power storage stacks 51, 52, and 53 can be reliably immersed. In addition, since the extinguishant E is discharged from the opened pressure release valve 40, a new extinguishant E at a low temperature state can be effectively supplied into the housing case 11. Accordingly, the temperatures of the power storage stacks 51, 52, and 53 can be effectively lowered.

In addition, since the fragile portion 25 is provided at a position lower than the plurality of power storage stacks 51, 52, and 53, the extinguishant E can be introduced into the housing case 11 from a position lower than the plurality of power storage stacks. The extinguishant E introduced into the housing case 11 is discharged from the pressure release valve 40 provided at a position higher than the plurality of power storage stacks, to the outside of the housing case 11. Therefore, the plurality of power storage stacks 51, 52, and 53 can be more reliably immersed.

Further, when viewed in a plan view, since the fragile portion 25 and the case-side fragile portion 15 are located between the power storage stacks adjacent to each other in the first direction, the extinguishant can be introduced into the housing case 11 by utilizing the gap located between the power storage stacks adjacent to each other.

### Other Modifications

In the above-described embodiment, the case where the cooler 20 is located below the power storage device 10 has been described as an example, but the present disclosure is not limited thereto, and the cooler may be located on the side or above the power storage device 10 as long as the cooler can cool the power storage stack.

In addition, the case where the case-side fragile portion 15 is provided in a portion of the housing case 11 facing the fragile portion 25 has been described as an example, but the present disclosure is not limited thereto. Instead of the case-side fragile portion 15, an opening may be provided. In this case, when the fragile portion 25 is broken by the pressure of the extinguishant E, the inside of the housing case 11 and the inside of the cooler 20, and thus the refrigerant circulation path 30 can communicate with each other through the opening and the fragile portion 25.

In addition, although the case where the extinguishant inlet 321 is provided in the tank 32 has been described as an example, the present disclosure is not limited thereto, and the extinguishant inlet may be provided in the pipe 31 or may be provided in another portion of the refrigerant circulation path 30 as long as the extinguishant E can be introduced.

Further, a detection unit that detects an abnormality of the power storage stack by a sensor may be provided, and when the abnormality is detected, the pressure of the refrigerant may be increased by increasing the load of the pump 34, and the fragile portion 25 and the case-side fragile portion 15 may be broken.

Although the embodiments of the present disclosure have been described, it should be construed that the embodiments disclosed herein are given by way of illustration in all respects, not by way of limitation. It is intended that the scope of the present disclosure is defined by claims, and encompasses all variations equivalent in meaning and scope to the claims.

What is claimed is:

1. A vehicle comprising:
one or more power storage stacks;
a housing case that houses the one or more power storage stacks;
a cooler that is placed adjacent to the housing case, refrigerant for cooling the one or more power storage stacks being allowed to flow through the cooler; and
a refrigerant circulation path that is placed outside the housing case and allows the refrigerant discharged from the cooler to be circulated through the refrigerant circulation path and introduced again into the cooler, wherein
the refrigerant circulation path is equipped with an extinguishant inlet that allows an extinguishant to be introduced into the refrigerant circulation path,
the cooler is equipped with a fragile portion to be broken by pressure of the extinguishant introduced from the extinguishant inlet into the refrigerant circulation path, to cause an inside of the housing case to communicate with the refrigerant circulation path, and
the housing case is equipped with a pressure release valve located higher than the one or more power storage stacks.

2. The vehicle according to claim 1, wherein
the housing case includes a facing wall portion facing the cooler, and
the facing wall portion includes a part that faces the fragile portion, and the part is equipped with a case-side fragile portion to be broken by pressure of the extinguishant introduced into the refrigerant circulation path.

3. The vehicle according to claim 1, wherein the fragile portion is located lower than the one or more power storage stacks.

4. The vehicle according to claim 1. wherein
the one or more power storage stacks include a plurality of power storage stacks arranged in a first direction orthogonal to a top-bottom direction, and
as seen in plan view, the fragile portion is located between the power storage stacks adjacent to each other in the first direction.
